(19) United States
(12) Patent Application Publication
(10) Pub. No.: US 2012/0304601 A1
(43) Pub. Date: Dec. 6, 2012

(54) SELF-ADJUSTING SADDLE PAD

(76) Inventor: Lynda Kathryn Crawford (FKA Kay Sabich), Onalaska, WA (US)

(21) Appl. No.: 13/486,897

(22) Filed: Jun. 1, 2012

Related U.S. Application Data
(60) Provisional application No. 61/493,299, filed on Jun. 3, 2011.

(51) Int. Cl. B68C 1/12

(52) U.S. Cl. 54/66

(57) ABSTRACT

The present application relates generally to an apparatus to be used as a saddle pad for laying on the back of a riding or pack animal to reduce pressure point, irritation, and injury. More particularly, the present application relates to a saddle pad that has self-adjusting features that can compensate for wide variances in the contours of an animal's back as well as various saddle configurations, and thus, can reduce the discomfort an animal that is associated with a saddle or weight load. The self-adjusting features are provided by at least one protective packet configured to be removably placed within at least one interior pocket of the saddle pad.

### CROSS-REFERENCE TO RELATED APPLICATION

This application claims the benefit of U.S. Provisional Application No. 61/493,299 filed on Jun. 3, 2011, the disclosure of which is hereby incorporated by reference in its entirety.

### BACKGROUND

It is well known that most saddles are not custom made to fit an individual horse. Most saddles are built with a rigid tree, which can create areas of increased pressure and discomfort if the saddle does not conform precisely to the often asymmetrical back of the horse. Even a saddle that initially fits correctly can cause discomfort if the horse loses or gains weight and/or muscle tone, or develops abnormalities on the surface of its back. A horse's back may also exhibit abnormalities such as calcified insect bites and lumps or muscle atrophy from old injuries, which can be irritated by the friction and pressure of a saddle. It is also known that a saddle which fits well while the horse is standing still may impinge or cause discomfort when the horse is in motion or turning. In addition, the underside of a saddle may not be symmetrical due to production defects, warping, damage and uneven flocking compression over time. Thus, in most instances, it is important to utilize a pad between the saddle and horse's back to provide cushioning and pressure absorption and distribution to prevent discomfort and possible injury to the horse.

However, even considering the benefits of pads, their use under riding saddles or other loads does not completely protect against discomfort or injury. When a saddle and its pad do not fit a horse, several disabilities can result, such as the creation of localized pressure points under the saddle where the majority of weight is transferred from the saddle or load. Such localization of force can rub or abrade the skin of the animal, thereby causing substantial discomfort or injury.

There have been numerous attempts to provide a pad or improved interface intended to protect riding or pack animals from the pressure applied from the weight and/or movement of a rider in a saddle, or from other weight loads applied to the animals' back. Saddle pads disclosed in the prior art tend to fall into several general categories:

a) Saddle pads designed primarily to absorb sweat and/or protect the saddle;

b) Saddle pads designed primarily to prevent the saddle from slipping; and

c) Saddle pads designed primarily to disperse pressure from the saddle and weight of the rider. These types of pads utilize various cushioning mediums such as foam, resin, gel, air bladders, or a combination of foam and air bladders. These cushioning mediums are either integrated into the structure of the pad device or are added in the form of shims, inserts or bladders.

However, many existing saddle pads fail to completely compensate for the variations in the individual animal's anatomy or otherwise fail to address additional problems leading to discomfort of the horse. For example, the difficulties with saddle pads designed to absorb sweat is that once the various materials used become saturated with sweat, they no longer provide for cooling airflow and start to retain heat. The retained heat results in increased irritation of the skin and can lead to the development of sores or ulcers.

The difficulties with pads designed as “non-slip” is that they do little to disperse pressure, tend to be unforgiving, and can irritate anomalies of the horse's back, such as calcified bug bites or injuries.

A problem associated with unitary foam pad configurations designed for pressure dispersement is that they do not address the often asymmetrical nature of a horse's back. Any individual anomaly in the contours of the animal can result in irritation and discomfort, notwithstanding the padding provided by the foam. Additionally, these pad configurations do not address variations in back and shoulder shapes found with many horses, including “downhill,” “uphill,” swayback, and high wither (neck bone)/narrow shoulder problems. As used herein, the term “downhill” refers to horses whose hindquarters are higher than their forequarters. This configuration tends to distort the rider's position forward and results in excessive pressure exerted on the front of the saddle tree causing the saddle to painfully press into the shoulder area. Conversely, as used herein, the term “uphill” refers to horses whose hindquarters are lower than their forequarters. This configuration tends to distort the rider's position backwards and results in excessive pressure exerted on the back of the saddle tree causing the saddle to painfully press into the loin area. Unitary foam pad configurations also tend to irritate bumps on the horse's back and often allow irregularities with the saddle base to transfer to the horse's back. In addition, with some horses, additional padding is required along both sides of the spine, but not the shoulder area. Therefore, a uniform application of foam over the entire back and shoulder area can result in the shoulder area being pinched (because of too much foam padding in areas that do not require it).

Foam shims are sometimes used to apply additional padding to specific areas that typically require extra protection. However, the difficulty with using a saddle pad incorporating foam shims is the problem of determining the correct thickness and placement of the shims, which can vary from horse to horse. If the shims are placed incorrectly, or are of excessive or insufficient thickness, the rider may actually create new sore spots and pressure points. Once the saddle is placed on the horse's back, one cannot easily determine if the shims are in the correct position or know if the improper placement of the shims has created new pressure point problems specific to the shims. Often, the determination of improper shim placement is not apparent until the horse indicates pain by poor performance or skin/muscle soreness. Even with systems that incorporate a diagnostic mold of the horse's back, it is difficult to quickly and easily construct a pad from multiple layers of foam shims that accurately reflects the mold. Furthermore, as described above, the back conformation of individual animals can vary over time due to the development of calcified insect bites, lumps, or muscle changes in the back contours due to injury, resulting in the reduced utility of the initial diagnostic mold. Finally, another difficulty encountered with this technique are the distinct pressure points created at the edges of the built up foam pads. These pressure points can cause discomfort or sores on the horse's back when pressure is applied at the abrupt edge of the foam build-up by tightening the girth/cinch.

To be effective, saddle pads incorporating air bladders must be impermeable in order to retain air pressure. As a result, such bladder-based pads do not breathe, will retain heat and moisture and, if overfilled, can create ridges of high pressure which can cause discomfort to the horse. In addition, it is difficult for the average user to determine the correct level to fill the air bladder.

Difficulties with gel saddle pads include their heavier weight and tendency to break down (become less viscous) with use. Moreover, as in the use of air bladders, gel-based saddle pads lack “breathability” and have high heat retention. Due to their thinness, gel pads are also of limited use in solving asymmetrical conformation problems, swayback issues, high wither/narrow shoulder problems, downhill conformation, saddle leveling needs, and the like. Furthermore, gel pads are susceptible to bottoming out, especially after a loss of viscosity, resulting in pressure points being applied to the animal's back.

Saddle pads that are custom created for an individual horse/saddle combination require a new mold/pad to be created if a different saddle is used, or if the horse's conformation changes due to training variations, weight loss or gain, muscle atrophy/development, or the development of cysts, and the like. This approach is not economically feasible for the majority of riders. For example, creating custom pads would be time and cost prohibitive for trainers who often ride multiple horses on various different saddles over the course of one day.

Additional interfaces are based on particulate filled pads that are intended to facilitate the breathability of the pad. However, the difficulty with the flaxseed filled harness saddle pad described in U.S. Pat. No. 351,212, issued to Shaffer, is that the flaxseeds are stuffed compactly into sewn compartments to form “corrugations” that are intended to reduce the contact surface with the horse. By preventing the shifting of the flaxseeds, these packed compartments provide minimal cushioning, do not conform around bumps and injuries on the horse's back, and can cause raised patterns and back irritation where the skin and muscle tissue swells under pressure into the depressions left between the sewn pockets.

Similarly, various quilting techniques, including the use of internal baffles, used to inhibit the movement of particulates within pads can create an overly bulky pad and cause undesirable patterns on the skin. Furthermore, quilting and baffle features of particulate-filled pads are not completely effective in preventing gravitational or motion migration of the particulates. These pads often exhibit settling of the particulate material at the bottom edge of the pad. If the pad is stuffed sufficiently full to prevent easy migration of particulates around the quilting baffles, the density of the pad is often too thick for many equine saddle fitting applications. Furthermore, such filled or overfilled pads exhibit a significant reduction of the cushioning effect and provide minimal molding or sculpting of the pad to the conformation of the horse's back. Thus, the pads fail to fill the voids between the horse's back and the saddle, which is critical to dispersing pressure evenly.

Conversely, under-filling pads to provide cushioning and adjustability results in undesirable migration of the particulates to the bottom edge of the pad. In addition, quilted pads do not provide the ability to quickly and reliably adjust the thickness of the particulates in a specific area in order to address conformational problems. For example, quilted and/or baffled pads do not allow for selective padding of certain areas while simultaneously avoiding padding in other areas. Finally, quilted and/or baffled pads do not provide sufficient space of unpadded area to accommodate the sensitive spine and do not allow for the adjustment of the width of the spine relief area. Therefore, despite the many different saddle pad designs and materials directed toward ameliorating the pressures exerted by saddles and their weight bearing loads, there remains a need for a saddle pad that is breathable, lightweight, stable, and can easily adjust to the contours of multiple animals and saddle configurations, while minimizing the accuracy or effort needed in the set-up and placement by the user. It is with a view to this and other outstanding needs and the disadvantages of the existing pads that the present invention has been devised.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure provides a self-adjusting saddle pad for laying on the back of an animal. The saddle pad comprises at least one envelope configured to lie laterally along at least one side of the animal. The envelope comprises an upper layer joined to a lower layer forming at least one interior pocket. The saddle pad also comprises at least one protective packet disposed within the at least one interior pocket. The protective packet comprises particulate fill material and a flexible outer sleeve.

In some embodiments, the saddle pad comprises one envelope configured to lie laterally along both sides of an animal. In some embodiments, the envelope has one interior pocket configured to receive and retain at least one protective packet.

In some embodiments, the saddle pad comprises a plurality of envelopes, each envelope forming at least one interior pocket, wherein at least one envelope is configured to lie laterally along each respective side of the animal. In some embodiments, the interior pocket of each envelope extends substantially across a length of the saddle pad. In some embodiments, a cumulative surface area of the interior pockets is at least 80% of a surface area of the saddle pad.

In some embodiments, the saddle pad comprises a plurality of envelopes configured to lie laterally along at least one side of the animal. In some embodiments, the interior pockets formed by the plurality of envelopes are separated by at least one region that is substantially perpendicular or substantially parallel to a lateral length of the animal, wherein the region is defined by a seam, bonding, or attachment of the upper and lower layers. In some embodiments, the interior pocket of at least one of the plurality of envelopes extends substantially across a length of the saddle pad.

In some embodiments, the interior pocket is configured to receive and retain at least one protective packet in a plurality of orientations. In some embodiments, the interior pocket is configured to receive a plurality of protective packets disposed in a variety of orientations, including partially overlapping orientations. In some embodiments, the envelope comprises a resealable closure for closing and opening the interior pocket to permit the retention or removal of protective packets placed therein. In some embodiments, the resealable closure comprises a hook and loop fastener, a zipper, a snap, or a button.

In some embodiments of the self-adjusting saddle pad, the at least one protective packet is removable. In some embodiments, at least one protective packet disposed in the interior pocket is attached to the upper and/or lower layer of the envelope at one or more locations along the flexible outer sleeve of the protective packet. In further embodiments, the at least one protective packet is removably attached. In other embodiments, the at least one protective packet is permanently attached. In some embodiments, the protective packet is tubular and extends a substantial length of the saddle pad when disposed within the interior pocket. In some embodiments, the at least one interior pocket is configured to receive at least one additional protective packet.

In some embodiments, the saddle pad includes at least two protective packets that are tubular and, when placed within an interior pocket, extend a substantial length of the saddle pad in a substantially parallel configuration. In some embodiments, the at least two protective packets are mutually attached at one or more points along their respective flexible outer sleeves. In further embodiments, one of the mutually attached protective packets is attached to at least the upper and/or lower layer of the envelope at one or more locations along the flexible outer sleeve of the protective packet.

In some embodiments, the protective packet is substantially square, rectangular or oblong, and can be removably placed within the at least one interior pocket in a plurality of orientations. In some embodiments, the flexible outer sleeve of the protective packet is permeable to air and moisture. The particulate fill material may be resilient or not resilient. In some embodiments, the particulate fill material is configured to sculpt to the contour of the animal upon application of pressure. In some embodiments, the particulate fill material is capable of limited flow within the protective packet upon application of pressure. The particulate fill material may be a natural material, such as cork, or the particulate fill material may be a synthetic material, such as closed cell foam particles.

In some embodiments, the upper layer and lower layer of the envelope are joined by a seam, adhesive bond, or fastener. In some embodiments, the upper layer and lower layer of the envelope are members of the same piece fabric and are differentiated by a fold in said piece fabric. The pad may further comprise a bottom layer joined to the upper layer or the lower layer of the envelope, wherein the lower layer is disposed between the upper layer and the bottom layer of the envelope.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an angled side perspective view of an embodiment of a self-adjusting pad constructed according to the principles described herein, including tubular and oblong protective packets;

FIG. 2 is a top perspective view of an embodiment of a self-adjusting pad illustrating the insertion/removal of a tubular protective packet into/from a side envelope pocket;

FIG. 3 is an exploded view of a self-adjusting pad illustrating an upper layer, lower layer, an optional bottom layer of material, and two optional positioning schemes, each comprising multiple protective packets;

FIG. 4A is an illustration of an embodiment where a self-adjusting pad is configured for use with a Western-style saddle; and

FIG. 4B is an illustration of an embodiment where a self-adjusting pad is configured for use with an English-style saddle.

### DETAILED DESCRIPTION

It is noted that the invention is described herein primarily in terms of a pad apparatus for laying on the back of a horse to reduce pressure points, irritation, and injury associated with the weight and motion of a rider in a saddle. The invention can be used with all types of riding saddles and equine sports disciplines, including use of the pad without a saddle for bareback riding (i.e. as a bareback riding pad). However, the invention is not so limited. Saddle pads according to the invention can also be configured for, or adapted to, other animals that are typically used for riding upon, including donkeys, mules, burrows, camels, elephants, and the like. Furthermore, the invention also encompasses pads used to protect animals from pressure applied by the placement of loads on the animals' backs (i.e. for pack animals).

Overview

The present application provides several improvements over the prior art. Described herein are various embodiments of a self-adjusting saddle pad for laying on the back of an animal to reduce pressure points, irritation, and injury associated with a saddle, weight of a rider, or weight load. In at least one embodiment, the pad is configured to self-mold to the contours of the animal's back and the shape of the saddle in response to the movements of the horse and the shifting pressure exerted, for example, from the weight of the rider in the saddle. The molding, or sculpting, of the pad results from the controlled flow of particulate material within discrete protective packets placed within pockets of the pad. As a result of the applied pressure and movement, a portion of the particulates flows in the protective packets in a manner that fills the spaces where the saddle and the horse's back do not contact properly. Thus, the pressure exerted by the saddle is dispersed evenly across a larger area of the horses back and pressure points are avoided. A further advantage of the self-adjusting aspect of the embodiments disclosed herein is that the padding (i.e. particulate material) flows away from areas requiring only light padding, thus avoiding pinching that would result from a unitary foam pad, quilted pad, or the like. Because the self-adjustment, or molding, occurs as a result of the riding forces during operation, the pad does not require the complicated, time consuming and expensive creation of back contour diagnostic molds in order to create a custom pad for each horse and saddle combination. Furthermore, any customization of the padding can be performed quickly, easily, and without requiring a high degree of accuracy. Another attendant advantage to the self-adjusting embodiments described herein is that they have the flexibility to allow the rider to easily incorporate additional self-adjusting padding to compensate for common equine conformational problems, but without requiring exacting placement or extensive saddle fitting knowledge by the rider. For instance, an embodiment described herein provides the flexibility of allowing the rider to “pad up” only one (or more) particular place(s) on a horse's back that need cushioning or conformation correction, leaving the rest of the pad envelope essentially unpadded. Such adjustments can be performed easily and without precise placement of the protective packet(s). Because of the controlled flow of particulate material within the protective packets, no sharp edges occur that would create a new pressure point on the horse. The vast flexibility of the saddle pads described herein permits their use with many different horse and saddle combinations with the ability to quickly and conveniently move the saddle pad from one horse to the next without time consuming customization, which is an important attribute for a trainer riding multiple horses in a day.

The saddle pads described herein also avoid any requirement for heavy or bulky padding, thus preserving a lower center of gravity and enhancing the stability of the saddle and rider, while minimizing the weight burden on the horse. The pad is durable, lightweight, and easy to install, adjust, remove, and clean. Furthermore, the pad can be used in all riding conditions and with all types of saddles.

An additional advantage of one embodiment of the pad described herein is that the pad does not have seams, stitching, bindings, any other artificial hard edges on the layer placed against the horse's skin that would exert pressure points and abrade the surface of the horse's back. The illustrative embodiment is also breathable and not heat restrictive, and thus avoids the buildup of sweat and heat on the horse's back. Therefore, the pads described herein eliminate the irritating and abrasive rubbing that can create hair loss and sores that are often associated with currently available pads.

### DESCRIPTION OF EXEMPLARY EMBODIMENTS

The following discussion is presented to enable a person skilled in the art to make and use the invention. Various modifications to the described embodiments will be readily apparent to those skilled in the art and the generic principles herein can be applied to other embodiments and applications without departing from the spirit and scope of the present invention as defined by the appended claims. Thus, the present invention is not intended to be limited to the embodiments described, but is to be accorded the widest scope consistent with the principles and features disclosed herein.

The present disclosure provides a self-adjusting saddle pad comprising at least one envelope. In some embodiments, the envelope comprises multiple layers of sheet material joined together to form at least one interior pocket. The number, placement, and orientation of the envelope(s) and the corresponding interior pocket(s) of the pad can vary within the scope and spirit of the present invention. For example, in one embodiment, the pad has a single envelope configured to lie laterally along both sides of the animal. The single envelope forms an interior pocket that is configured to receive and retain at least one protective packet on one or both sides of the animal's back, for example a horse's back. The one or more protective packet(s) can be disposed within the interior pocket. The protective packets can be removably placed within the interior pocket. Alternatively, at least one protective packet can be permanently attached to the upper or lower layers of the envelope at one or more points along the flexible outer sleeve. The first, or additional protective packets, can be removably placed within the interior pocket through openings optionally placed at any location in the envelope, such as locations along the outer periphery, along the central anterior/posterior axis, or other locations on the surface of the envelope. The openings preferably include resealable closures. The pad may be configured to allow placement, removal and/or adjustment of the protective packet(s) in the interior pocket of the envelope after the pad has been placed on the horse's back. However, the pad is preferably configured to permit placement, removal, and/or adjustment of the protective packet(s) before placement of the pad on the horse's back.

In some embodiments, the self-adjusting saddle pad comprises multiple layers of sheet material and has a centrally placed longitudinal spine region. The pad has a plurality of envelopes, with at least one envelope disposed on each side of the longitudinal spine region of the pad. In this configuration, envelopes are configured to lie laterally along each side of the animal.

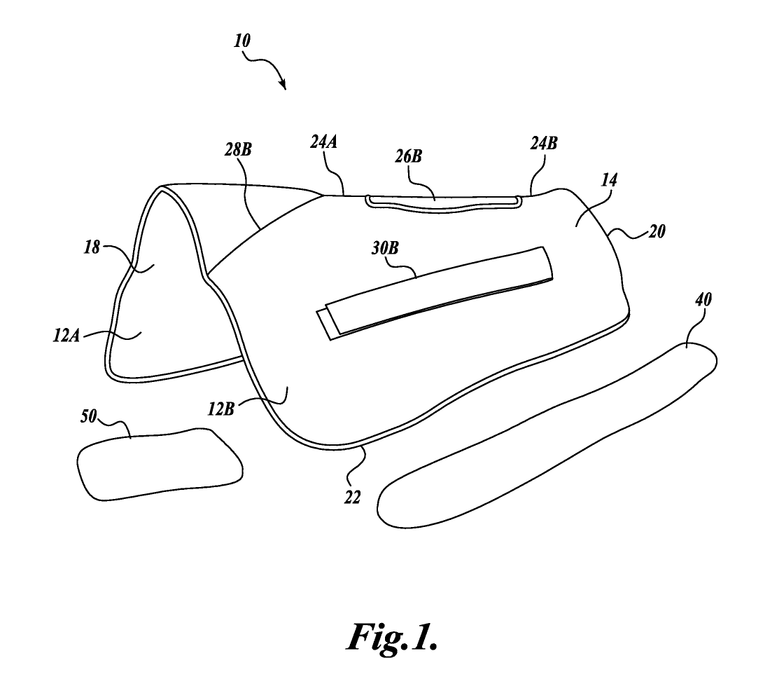

FIG. 1 provides an angled side perspective view of an embodiment of a self-adjusting saddle pad 10 with associated particulate-filled protective packets 40, 50 prior to placement within the envelopes of the pad. Although only one protective packet 40 and one protective packet 50 are illustrated in FIG. 1, it is contemplated that in many implementations of the saddle pad, that multiple packets, such as illustrated by the packets 40 and/or 50, will be used. The embodiment of the pad 10 in FIG. 1 comprises two envelopes 12A, 12B configured to lie laterally along the right and left sides, respectively, of an animal's body. The right envelope 12A and left envelope 12B are separated by a center seam that (when in use) corresponds to the spine region of an animal. The center seam is illustrated here as having an anterior center seam 24A and posterior center seam 24B. Optional wither seams 28A (not shown) and 28B are also provided.

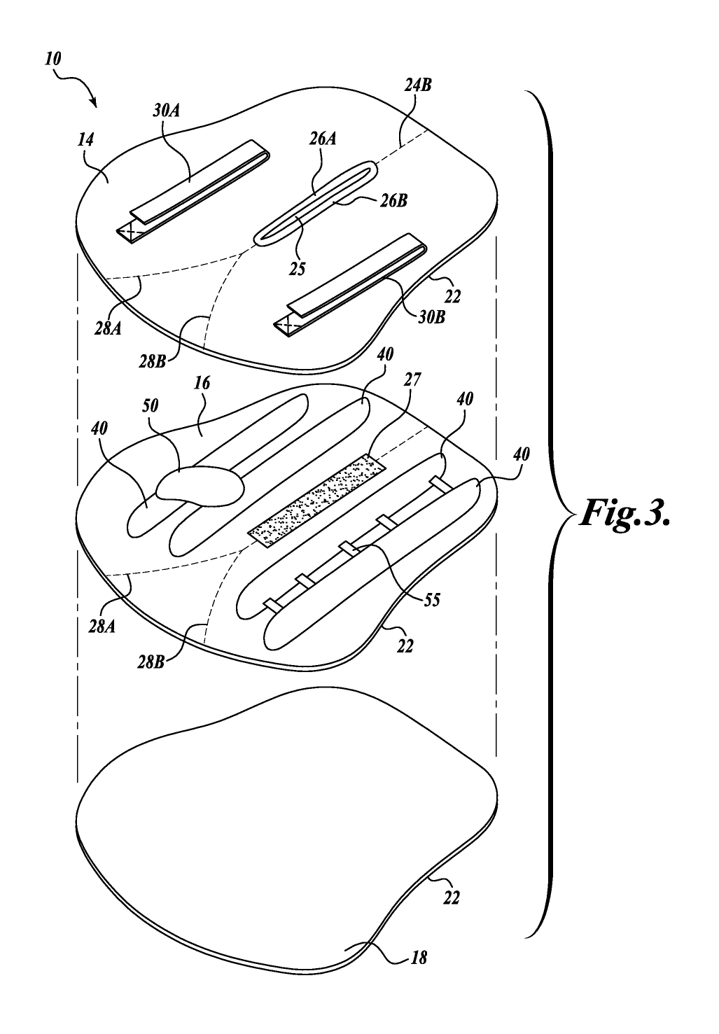

The saddle pad side envelopes 12A, 12B comprise an upper layer 14 of material, and a lower layer 16 of the material (see FIG. 3). Furthermore, an optional bottom layer 18 of material can be disposed underneath the lower layer 16 (see FIG. 3). The multiple layers (i.e. upper layer 14, lower layer 16, and optional bottom layer 18) can be joined by a single seam 20 extending around the outside edges of the saddle pad envelopes 12A, 12B.

Also shown in FIG. 1 is an optional strap 30B attached to the upper layer 14 of the left saddle pad envelope 12B that can be used to help anchor the pad 10 to a saddle. A corresponding optional strap 30A attached to the right envelope 12A is not shown in this view. The optional straps 30A, 30B may use a hook and closure to anchor the pad to the saddle by fastening around the billet straps of the saddle. The placement of the optional straps 30A, 30B is variable depending on the type of saddle used on the animal. For example, in another embodiment, the optional straps 30A, 30B may be located at the anterior edge of the pad 10 at the point where optional whither seams 28A and 28B intersect in order to attach the pad 10 to the breast collar D-rings located on an English saddle, providing enhanced stability to the pad 10 and saddle. In another embodiment, the straps 30A, 30B may be omitted, as for many horses, the settling and molding of the saddle into the particulate filled packets 40, 50 will assist in keeping the saddle in its correct position under the saddle.

Still referring to FIGS. 1 and 3, the side envelopes 12A, 12B form interior pockets consisting of the internal space disposed between the upper layer 14 and the lower layer 16. The interior pockets are accessible through openings in the envelopes. As illustrated in the embodiment illustrated in FIG. 1, the left pocket has a pocket opening 26B disposed adjacent and parallel to the center seams 24A, 24B corresponding to the spinal region. Likewise, the right pocket has a pocket opening 26A, also disposed adjacent and parallel to the center seams 24A, 24B. Alternative embodiments in which the location and orientation of the openings are different are also contemplated within the scope of the present invention. For example, the pocket openings may be placed at locations along the outer periphery or at any location on the surface of the envelope that permits access to the interior pockets. The pocket openings 26A and 26B are configured to permit the easy insertion and removal of particulate-filled protective packets of various sizes and shapes, such as tubular packets 40 and oblong-shaped packets 50, into and out of the pockets formed by the side envelopes 12A, 12B.

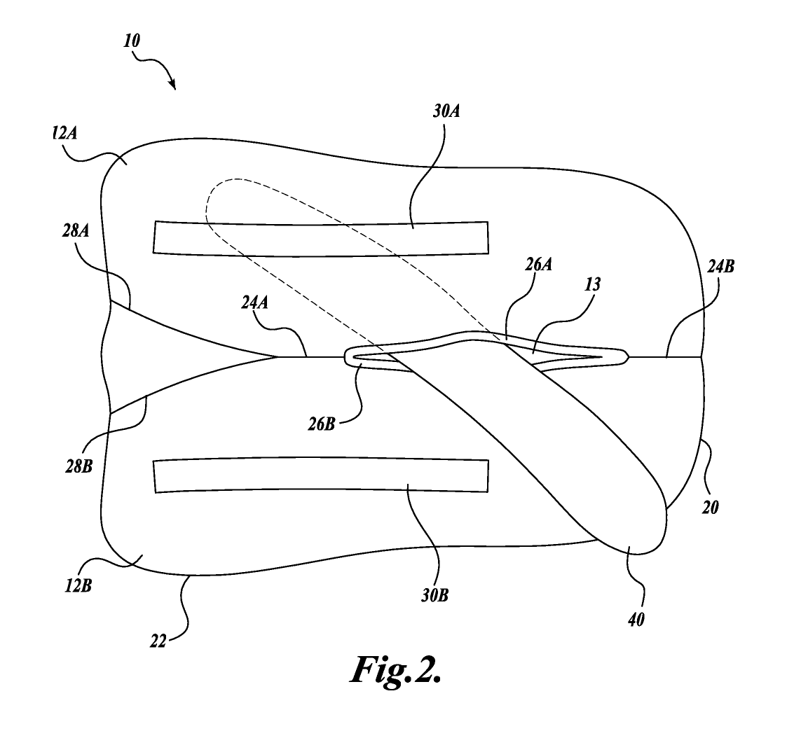

FIG. 2 is a top view of the self-adjusting saddle pad 10 and illustrates the capacity to insert or remove particulate-filled protective packets. Specifically, FIG. 2 illustrates the partial insertion (or removal) of a tubular-shaped protective packet 40 into the pocket 13 formed by the side envelope 12A. As shown, the pocket 13 is accessed through an opening (26A or 26B, corresponding to the right or left pockets, respectively, as described relative to the animal's body). The pocket 13 is bound by the anterior center seam 24A, the posterior center seam 24B, the circumferential seam 20 and the wither seam 28A or 28B. The openings 26A, 26B may optionally comprise structures for temporarily closing or fastening the pockets shut, thus creating resealable closures. The structures can comprise, for example, button(s), snap(s), zipper(s), latch(es), or a complementing hook and loop closure system (for example VELCRO®). The presence of a specific structure for securing or closing the pockets preferably does not interfere with the insertion and removal of the protective packets 40, 50 when the pocket openings 26A, 26B are in the open configuration.

FIG. 3 provides an exploded perspective view of the saddle pad 10. Specifically, FIG. 3 illustrates the upper layer of material 14, the lower layer of material 16, and the optional bottom layer of material 18. Because each layer is illustrated as lying flat on a single plane, characteristics of the right and left sides are visible. As described above, the right and left side envelopes are formed by joining of the upper layer 14 and lower layer 16 of materials. The layers are typically joined at the outer periphery of the pad, and along the anterior center seam 24A, the posterior center seam 24B, and the right and left wither seams 28A, 28B. In the illustrated embodiment, the upper layer 14 has a single slit 25 centrally placed between each side envelope, and extending along the anterior-posterior axis between the anterior center seam 24A and the posterior center seam 24B. The slit 25 is bordered by the openings 26A, 26B that provide access to the interior right and left pockets, respectively. The underside surfaces associated with these pocket openings 26A, 26B optionally comprise structures for temporarily closing or fastening the pocket, for example a hook or loop component of a hook and loop fastener system. This attaches the complementary loop or hook component 27 disposed at a corresponding location on the lower layer 16 of material to the underside surface of the pocket openings 26A, 26B. As in FIGS. 1 and 2, optional straps 30A and 30B are illustrated. The straps can be bonded, sewn, or otherwise affixed to the top surface of the upper layer 14 if needed to help secure the pad 10 to a saddle.

The side envelopes 12A, 12B have been described as being formed by the joining of the upper layer 14 and the lower layer 16 of material at the periphery by a seam. However, an alternative embodiment provides side envelopes that are formed by a single piece of cloth that is folded over to create an upper layer 14 and lower layer 16 of material. Thus, at least one edge of the pad periphery may lack a seam.

Protective padding is provided by the use of particulate-filled protective packets 40, 50. The isolation of particulate material in packets prevents excessive shifting or settling of the particulate material, while providing the capacity to strategically provide protective padding in areas determined to be in need of padding. The expansive nature of the interior pockets formed by the envelopes 12A, 12B permits great flexibility in the placement of one or more particulate-filled protective packets within the pockets, as determined by the needs of the animal and rider. As will be understood by skilled practitioners in the art, the saddle pad of the present invention can comprise protective packets that are removably placed within the interior pocket, protective packets that are attached to the upper layer and/or lower layer of the interior of the envelope, or a combination of attached and removably placed protective packets. The placement and/or attachment of the protective packets can be in any configuration or orientation as required by the padding needs of the rider and/or animal. Several illustrative, non-limiting configurations are provided.

In some embodiments, tubular protective packets 40 can be placed or disposed (e.g., attached) longitudinally in the pocket, extending substantially along the anterior to posterior axis of the pad 10. Additionally, multiple tubular protective packets 40 placed in such an orientation can be arranged side by side (i.e. in parallel) from the bottom edge 22 of the pad toward the center seam 24A, 24B. This results in the protective packets lying along the horse's back lateral to the spine. FIG. 3 illustrates two exemplary embodiments of such placement of protective packets within the envelope pockets.

In one exemplary embodiment, FIG. 3 specifically illustrates two tubular protective packets 40 placed or disposed in substantially parallel configuration between the lower layer 16 of material and the upper layer 14 of material, within the pocket corresponding to the right envelope 12A (corresponding to the animal's right side). This arrangement brings the tubular protective packet 40 most proximal to the center seam up against an optional left wither seam 28A at the anterior end and against the posterior edge of the saddle pad.

The square or oblong-shaped particulate-filled protective packet 50 may also be inserted into the pockets 13, with or without tubular-shaped protective packets 40. In some embodiments, an oblong protective packet 50 may be placed in a position that overlaps (above or below) with one or more longitudinal, tubular particulate-filled packets 40. In the embodiment illustrated in FIG. 3, the oblong protective packet 50 in the pocket corresponding to the right envelope 12A (corresponding to the animal's right side) is placed over two substantially parallel tubular packets 40. These embodiments utilizing additional oblong or other shaped packets provide additional padding when needed at any place within the pocket of the side envelope 12A or 12B. Alternatively, as few as one oblong-shaped protective packet 50 can be placed in one side envelope 12A or 12B when only minimal padding is required at a specific spot between the saddle and the animal's back.

In a second exemplary embodiment, FIG. 3 specifically illustrates two tubular protective packets 40 placed in substantially parallel configuration between the lower layer 16 of material and the upper layer 14 of material, within the pocket corresponding to the left envelope 12B (corresponding to the animal's left side). This arrangement brings the tubular protective packet 40 most proximal to the center seam up against an optional left wither seam 28B at the anterior end and against the posterior edge of the saddle pad.

In this illustrated embodiment, the two substantially parallel tubular protective packets 40 are mutually attached at a plurality of points along their flexible outer sleeves. However, it will be understood that the tubular protective packets 40 can be mutually attached at one or more points along their flexible outer sleeves, including at a continuous border. The packets can be mutually attached in any reversible or irreversible manner known in the art. In the illustrated embodiment, the one or more attachments comprise the application of fasteners 55. The fasteners 55 can be any such devices known in the art, for example, discrete tabs with a complementary hook and loop system (e.g., VELCRO®), a button and loop system, a button and button-hole system, snaps, and the like. In other embodiments, the tubular protective packets 40 are attached along a continuous border, such as provided by a sewn or bonded seam, a zipper, or an elongated fastener 55 placed lengthwise on each packet. An illustrative example of an elongated fastener 55 on each packet is a single, elongated tab placed lengthwise along the substantial length of each packet, each tab with a complementary hook and loop system (e.g., VELCRO®). It is also contemplated that the protective packets can be formed from two layers of flexible outer sleeve material with a plurality of substantially parallel seams irreversibly connecting the layers, defining at least two substantially parallel tubular interior spaces within the layers of the flexible outer sleeve material that contain the fill material. In this embodiment, the seams prevent flow of fill material between the tubular protective packets.

In some embodiments, at least one of the mutually attached protective packets can also be attached to the lower layer and/or upper layer of the envelope. The attachment to the envelope layer(s) forming the interior pocket can be reversible or irreversible, according to any means or manner known in the art, such as those described herein.

While the description of these exemplary embodiment comprising mutually attached tubular protective packets focuses on the relationship of two tubular protective packets, the invention is not limited in this aspect. The invention also provides three or more protective packets that can be mutually attached in a series (i.e., packet 1 is mutually attached to packet 2, packet 2 is mutually attached to packet 3, and so on.)

In some embodiments, a self adjusting pad comprising an upper layer 14 and a lower layer 16 may be completely enclosed in an independent cover. The cover provides an outer layer of protective material lacking any stitching, seams, edging, and the like, that would interface with the horse's back with minimal rubbing and abrasion.

Still referring to FIG. 3, in additional embodiments, a bottom layer 18 of material is also included in the pad, disposed underneath the lower layer 16, on the side opposite of the upper layer 14. In this embodiment, the three layers are preferably attached with a single outer seam by stitching or other bond along the outer periphery of the pad. The advantage of this embodiment is that there is no stitching, edging, or other irregularities present on the bottom layer 18 that would correspond to the center seam, wither seams, openings, hook and loop closures, straps, and the like. The lack of such stitching, edging, and irregularities provides a smooth surface to contact the horse's back and, thus, avoids rubbing and irritation that can cause hair loss and sores. The inclusion of the bottom layer 18 also avoids wrinkling or twisting of material that can occur in independent covers, described above, which can lead to irritation and sores. Moreover, the bottom layer 18 provides additional structure to help maintain the integrity of the pad.

The layers for the pad are preferably made from any suitable material that is flexible, durable and easily cleaned. As used herein, the term “flexible” refers to the ability of the material to bend or flex without injury or damage, though in some embodiments, the term “flexible” does not refer to any stretch or elasticity characteristics of the material. In preferred embodiments, the material is flexible, exhibits minimal stretching or elasticity, and is breathable. The breathable characteristic of these embodiments permits the movement of heat and moisture away from the horse's back, enhancing comfort and reducing irritation. The material may comprise, for example, natural or synthetic fibers. Exemplary materials include nylon, acrylic, wool, hemp or cotton, as well as other materials.

As with the materials for the pad layers, the outer casing for the protective packets 40, 50 may be made of any material that is durable, malleable and easily cleaned. Additionally, the material is preferably breathable to facilitate the escape of moisture and heat from the surface of the horse's back. In one embodiment, the casing of the protective packets 40, 50 is made of a flexible or elastic material. The flexibility and/or elasticity of the casing facilitates the sculpting or molding of the particulate fill material in the protective packets 40, 50 to the contours of the saddle and horse's back. Furthermore, the flexibility and/or elasticity of the casing facilitates the melding together of packets that can self-adjust under pressure to create overlapping configurations to avoid hard edges. Thus, when compressed, the packets provide a consistent surface against the horse's back, minimizing indentations or sharp edges that could irritate or cause unequal pressure on the horse's back. Exemplary materials for the protective packet casing include, without limitation, nylon, acrylic, polyester, wool, hemp, and spandex jersey material. In another embodiment, the casing can also be made of a non-elastic material, such as, for example, polypropylene, and woven or unwoven fiberglass.

A person of ordinary skill in the art will recognize that the padding characteristics of the protective packets 40, 50 can vary depending on the character of the particulate fill material contained therein and the degree of packing of the material. The particulate fill material may be any material, natural or synthetic material, that can disperse pressure applied to the packet while retaining air pockets interspersed throughout. The particulate material need not be resilient, but preferably exhibits moderate flow characteristics upon application of pressure. The term “moderate flow characteristics” is used to refer to the ability of a portion of the particulate material to move away from a point of applied pressure to facilitate sculpting, but retaining a portion of the particulate material at the point of pressure sufficient to disperse the pressure in the surrounding directions (i.e. to avoid “bottoming out” of the packet). Furthermore, the particulate is preferably made of a lightweight material.

In one preferred embodiment, the packets are partially filled with cork particulates, a material known commercially for its natural anti-bacterial, non-absorbent, and lightweight attributes. Furthermore, cork can be sustainably harvested. Air spaces between the cork particulates compress to varying degrees when pressure is applied. However, even under pressure, air spaces remain between the particles, thus preserving a packet that is porous and retains its breathable characteristics, allowing the horse to cool itself through the evaporation of sweat. Furthermore, cork particles exhibit moderate flow characteristics upon compression, thus permitting the particles to settle within the packet without losing air pockets. This partial settling results in excellent sculpting or molding attributes, and permits the protective packets to “fill in” surrounding contours and eliminate any gaps present between the saddle and the horse's back.

An ultimate result of the sculpting of the packets is that the pad can self-adjust during use. In this regard, the protective packets adjust during operation to alleviate the bridging that occurs when areas of the saddle are unsupported and, thus, prevent pressure points at points surrounding the gap on the horse's back. Stated differently, the compression applied during use, combined with the movement of the horse, facilitates the molding of the packets to the contours of the saddle and horse, and the applied pressure is distributed evenly across a large area without peak pressure points.

In other embodiments, the particulate fill material may comprise closed cell foam or other synthetic material.

As indicated, the padding characteristics of the protective packets can also vary depending on the degree of packing of particulate material within the protective packets. For example, packets filled to full capacity by gravity or packed beyond 100% gravity capacity (by stuffing or subsequent restriction of the casing) provide less opportunity for flow of the particulate material. Depending on the degree of flexibility of the casing material, the packets can be filled to a high capacity (i.e. approaching and/or exceeding 100%) to prevent sharp pressure points from dispersing all of the particulate material and causing the packet to “bottom out”. It is preferred, however, that the particulate material have moderate flow characteristics within the packet to facilitate the molding or sculpting of the protective packet to the contours of the saddle and horse (i.e. to facilitate self-adjustment). Therefore, in some embodiments, the packets are filled to a capacity less than 100%, such as 90%, 80, 70%, or less, depending on the degree of flow that is desired.

As indicated above, the particulate-filled protective packets 40, 50 can be of varying sizes shapes, such as tubular, square, rectangular and oblong. In one embodiment, the particulate-filled packets 40 are constructed in a tube-like shape, each as long as substantially the length of the saddle pad from the anterior to posterior edges, as illustrated herein in FIGS. 1-3. In one embodiment, a series of one, two, three or more of these longitudinal particulate-filled packets are disposed next to each other, in substantially parallel configuration, in each pocket on one or both sides of the saddle pad. The plurality of protective packets can include protective packets that are removably placed or attached, including a combination thereof. Two or more substantially parallel packets may also be mutually attached at one or more points of contact, including along a continuous border, in their respective flexible outer sleeves. The mutual attachment provides additional stability in the placement of the protective packets, and thus prevents settling of the fill material within the pad during use.

Two illustrations of a pad with a series of two tubular packets 40 are provided in FIG. 3. These embodiments create a single layer padding foundation that extends from the bottom edge of the pad toward the spine of the saddle pad, leaving the area of the saddle pad that sits over the horse's spine free of padding so as to prevent pressure and impingement on the sensitive spine of the horse. The horizontal orientation of the tubular packets prevents gravitational settling of the particulate material to the bottom edge (element 22 in FIGS. 1-3) of the pad. Furthermore, it is possible to vary how close the padding is to the horse's spine by adding or removing the longitudinal packets 40.

Another advantage of the arrangement described above is the ability to repetitively shake the saddle pad in one or more directions before placing the pad on the horse. This allows the user to easily and strategically position more of the particulates towards the front or towards the back of the longitudinally-placed tubular packets, depending on where in the saddle pad the heavier padding is desired. Thus, this arrangement permits the easy customization of the padding before riding and the self-adjustment of the padding during operation, all the while preventing the subsequent settling of the particulate to the bottom edge of the pad due to gravitational and movement forces.

In another embodiment, the particulate-filled packets 50 are constructed in a square, rectangular, round, and oblong shapes that can be used individually with or without the longitudinal packets 40 as described above. In one embodiment, a square, rectangular, round, or oblong-shaped packet is used individually, without the longitudinal tubular packets, to pad specific areas of the horse's back while leaving the rest of the saddle pad without padding from the protective packets. Alternatively, one or more additional square, rectangular, round, or oblong-shaped packets can be placed on top of the longitudinal tubular packets to increase the thickness of the padding in specific areas as needed, as described above and illustrated in FIG. 3, in the pocket corresponding the right envelope 12A (corresponding to the animal's right side).

In one embodiment, the packets 40, 50, regardless of shape or number, rest in the saddle pad pocket without being anchored to the saddle pad pocket or to each other. This results in a saddle pad in which it is very easy to add, subtract or rearrange the packets. However, the present invention also contemplates embodiments wherein the protective packets are anchored to the saddle pad and/or to each other by various means such as hook and loop closure or stitching. As illustrated in FIG. 3 and described above, two or more protective packets can be mutually attached at one or more points of contact with fasteners 55 in their respective flexible outer sleeves or along a continuous border between their respective flexible outer sleeves.

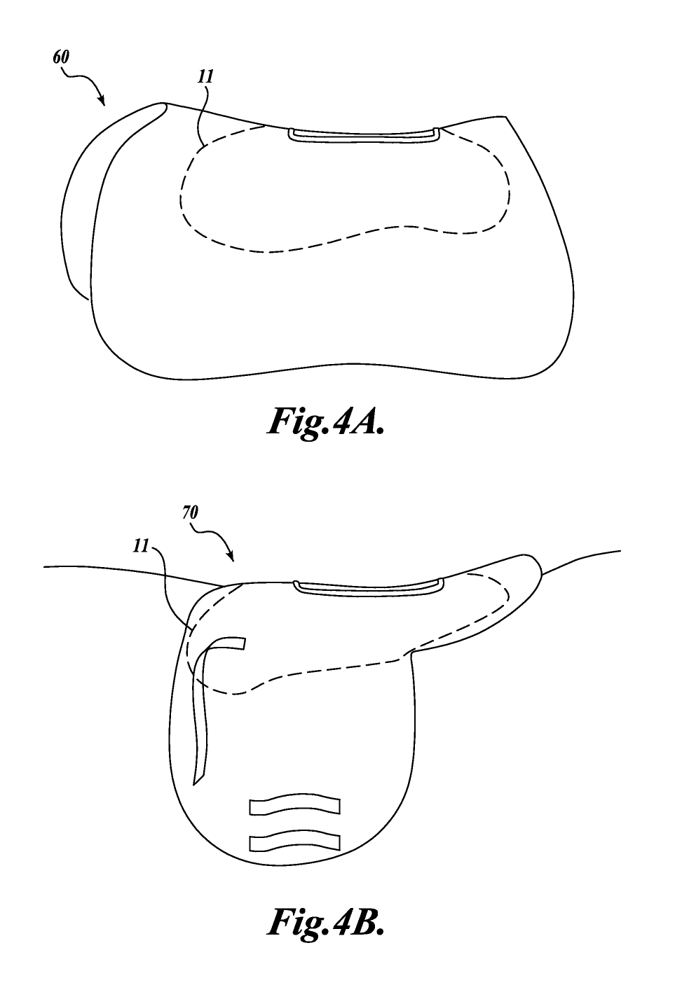

FIG. 4A illustrates a side view of part of a Western saddle 60, and indicates in dashed lines 11 how a saddle pad as described herein may be positioned underneath the saddle 60. In some embodiments, the saddle pad 10 is secured to the saddle 60, such as by stitching, by straps (as described above), or by attaching it with hook and loop attachments. Alternatively, the saddle may be placed over the self-adjusting saddle pad 10 and held thereto by gravity. As explained above, in most cases, the settling and molding of the particulates in the protective packets in the pad will conform to the contours of the saddle and the horse, thus providing enhanced stability for the saddle.

FIG. 4B illustrates a side view of part of an English saddle 70, and indicates in dashed lines 11 how a saddle pad 10 as described herein may be positioned underneath the saddle 70. In some embodiments, the saddle pad 10 is secured to the saddle 70, such as by stitching, by straps (as described above), or by attaching it with hook and loop attachments. As above, the saddle 70 may alternatively be placed over the self-adjusting saddle pad 10 and held thereto by gravity. As explained above, the settling and molding of the particulates in the protective packets in the pad will conform to the contours of the saddle and the horse. This provides enhanced stability to the saddle.

The embodiments described herein are generally presented in the context of what is commonly referred to as a “half pad” shaped saddle pad. It will be apparent to persons of ordinary skill in the art that there are many ways to modify the embodiments described herein to adjust the shape and style of the pad to conform to a variety of saddles. Thus, the present invention encompasses an array of shapes, sizes and other designs as contemplated by the general principles described herein. Self-adjusting saddle pads may be created in any shape for any type of equestrian discipline, including but not limited to English saddle pad, half pad, full pad, dressage pad, jump pad, endurance pad, eventing pad, all-purpose pad, side-saddle pad, vaulting pad, racing pad, polo pad, Western pad, Western square skirt pad, Western round skirt pad, barrel racing pad, Western endurance pad, and the like. The saddle pads described herein can be placed between the saddle and the horse. Alternatively, the saddle pads can be placed between the saddle and rider to function as a “seat-saver.” The present invention also encompasses pads that are not associated with saddles, such as with bareback riding pads or pads placed beneath loads on pack animals. Moreover, for each shape/type of saddle pad, several sizes are contemplated, due to the different sizes and lengths of saddles available. The inventive self-adjusting saddle pad described herein may be incorporated into other types of existing saddle blankets/pads, padding systems, or saddles. Alternatively, existing saddle blankets or pads may be modified to include the pockets and protective packets of the present invention, such as by sewing or stitching side envelopes onto the bottom or top of other types of saddle blankets or pads and using at least one protective packet, according to the present invention.

While preferred embodiments of the invention have been illustrated and described, it will be appreciated that various changes can be made therein without departing from the spirit and scope of the invention.

The embodiments of the invention in which an exclusive property or privilege is claimed are defined as follows:

1. A self-adjusting saddle pad for laying on the back of an animal, the saddle pad comprising:
at least one envelope configured to lie laterally along at least one side of the animal, wherein the envelope comprises an upper layer joined to a lower layer forming at least one interior pocket; and
at least one protective packet disposed within the at least one interior pocket, wherein the at least one protective packet comprises particulate fill material and a flexible outer sleeve.

2. The self-adjusting saddle pad of claim 1, wherein the saddle pad comprises one envelope configured to lie laterally along both sides of an animal.

3. The self-adjusting saddle pad of claim 1, wherein the saddle pad comprises a plurality of envelopes, each envelope forming at least one interior pocket, wherein at least one envelope is configured to lie laterally along each respective side of the animal.

4. The self-adjusting saddle pad of claim 3, wherein at least one interior pocket of each envelope extends substantially across a length of the saddle pad.

5. The self-adjusting saddle pad of claim 3, wherein a cumulative surface area of the interior pockets is at least 80% of a surface area of the saddle pad.

6. The self-adjusting saddle pad of claim 1, wherein the saddle pad comprises a plurality of envelopes configured to lie laterally along at least one side of the animal.

7. The self-adjusting saddle pad of claim 6, wherein the interior pockets formed by the plurality of envelopes are separated by at least one region that is substantially perpendicular to or substantially parallel to a lateral length of the animal, wherein the region is defined by a seam, bonding, or attachment of the upper and lower layers.

8. The self-adjusting saddle pad of claim 6, wherein the interior pocket of at least one of the plurality of envelopes extends substantially across a length of the saddle pad.

9. The self-adjusting saddle pad of claim 6, wherein a cumulative surface area of the interior pockets is at least 80% of a surface area of the saddle pad.

10. The self-adjusting saddle pad of claim 1, wherein the interior pocket is configured to receive and retain at least one protective packet in a plurality of orientations.

11. The self-adjusting saddle pad of claim 1, wherein the envelope comprises a resealable closure for closing and opening the interior pocket to permit the retention or removal of protective packets placed therein.

12. The self-adjusting saddle pad of claim 11, wherein the resealable closure comprises at least one of a hook and loop fastener, a zipper, a snap, or a button.

13. The self-adjusting saddle pad of claim 1, wherein at least one protective packet is removable.

14. The self-adjusting saddle pad of claim 1, wherein the at least one interior pocket is configured to receive at least one additional protective packet.

15. The self-adjusting saddle pad of claim 1, wherein the at least one protective packet is tubular and extends a substantial length of the saddle pad when disposed within the at least one interior pocket.

16. The self-adjusting saddle pad of claim 15, wherein the at least one protective packet is attached to at least one of the upper layer or lower layer of the envelope at one or more points along the flexible outer layer of the protective packet.

17. The self-adjusting saddle pad of claim 1, wherein the saddle pad comprises at least two protective packets disposed within the at least one interior pocket, wherein at least two protective packets are mutually attached at one or more points along their respective flexible outer sleeves.

18. The self-adjusting saddle pad of claim 1, wherein the flexible outer sleeve of the at least one protective packet is permeable to air and moisture.

19. The self-adjusting saddle pad of claim 1, wherein the particulate fill material is resilient.

20. The self-adjusting saddle pad of claim 1, wherein the particulate fill material is configured to sculpt to the contour of the animal upon application of pressure.

21. The self-adjusting saddle pad of claim 1, wherein the particulate fill material is capable of limited flow within the protective packet upon application of pressure.

22. The self-adjusting saddle pad of claim 1, wherein the particulate fill material comprises cork particulate or closed cell foam particulate.

23. The self-adjusting saddle pad of claim 1, wherein the upper layer and lower layer of the envelope are joined by a seam, adhesive bond, or fastener.

24. The self-adjusting saddle pad of claim 1, wherein the upper layer and lower layer of the envelope are members of the same piece fabric and are differentiated by a fold in said piece fabric.

25. The self-adjusting saddle pad of claim 1, wherein the saddle pad further comprises a bottom layer joined to the upper layer or the lower layer of the envelope, wherein the lower layer is disposed between the upper layer and the bottom layer of the envelope.
